(19) United States
(12) Patent Application Publication
(10) Pub. No.: US 2016/0285736 A1
(43) Pub. Date: Sep. 29, 2016

(54) Access method and system for virtual network

(71) Applicant: ZTE CORPORATION, Guangdong (CN)

(72) Inventor: Zhongyu Gu, Shenzhen (CN)

(73) Assignee: ZTE CORPORATION, Shenzhen, Guangdong (CN)

(21) Appl. No.: 14/891,461

(22) PCT Filed: May 17, 2013
(86) PCT No.: PCT/CN2013/075844

§ 371 Date: Dec. 29, 2015

(30) Foreign Application Priority Data
Aug. 31, 2012 (CN) 201210318773.5

(51) Int. Cl. H04L 12/751; H04L 12/46; H04L 12/741

(52) U.S. Cl. CPC H04L 45/02; H04L 45/745; H04L 12/4641

(57) ABSTRACT

Disclosed are methods and systems for accessing a Virtual Network (VN). The method includes: a Broadband Network-Network Virtualization Edge (BN-NVE) accepts access of a broadband user terminal to a VN in a data centre, and generates a forwarding table about the VN and its corresponding table entry; the BN-NVE performs interaction with an NVE of the VN to be accessed with respect to information of the forwarding table to synchronize information of the forwarding table of the VN; and the BN-NVE searches the forwarding table about the VN according to a destination address of a message of the broadband user terminal, forwards the message after tunnel encapsulation to a destination NVE in the VN, and forwards the message to a destination Virtual Machine (VM) through the destination NVE to implement VN access of the broadband user terminal. Another method includes: a VN service development and management entity in a data centre accepts an access request of a broadband user terminal for a VN in the data centre, and selects an NVE of the VN as an access NVE of the VN; and the access NVE of the VN establishes a security tunnel with the broadband user terminal, and implements VN access of the broadband user terminal through the established security tunnel. By the disclosure, the problem that a data centre gateway becomes a bottleneck when an Internet user accesses the VN in the data centre is solved.

### TECHNICAL FIELD

The disclosure relates to the technical field of network communications, and in particular to a method and a system for accessing a Virtual Network (VN).

### BACKGROUND

The L2 “Network Virtualization Over L3” overlay (NVO3) research group is a research group of the Internet Engineering Task Force (IETF) for providing a multi-tenant network for a data centre. The NVO3 research group is devoted to implementing a multi-tenant network for a data centre on the basis of an overlay-network-based network virtualization technology. FIG. 1 is a diagram of an NVO3 network structure for a data centre. As shown in FIG. 1, there exists a data centre gateway in the network structure, and the data centre gateway is configured to realize a connection between an Internet user and a VN in the data centre. However, there is yet no specific implementation solution to realize a connection between an Internet user and a data centre by a data centre gateway. An Internet Protocol Security (IPsec) tunnel is generally considered for implementing secure access and isolation of a user. Since a VN is a network required to be completely isolated from the Internet and other users, it is necessary to securely isolate a single user accessing the Internet. An IPsec tunnel may be adopted to realize an IPsec connection between a machine of the user and a data centre gateway, and then the user may be securely connected and isolated.

A VN is organized and isolated by virtue of IP tunnel connections among Network Virtualization Edges (NVEs) connecting Virtual Machines (VMs), and a data centre gateway does not participate in the organization and isolation of the VN. That is, when an Internet user is required to access through a data centre gateway, it is necessary to introduce a content of a VN into the data centre gateway. As such, a corresponding configuration for each VN in the data centre gateway is required.

Similarly, enterprise users have their own networks, and usually access the Internet through routers/firewalls. Therefore, it is also necessary to realize connections with VNs in a data centre through a mechanism similar to IPsec, and thus the enterprise users are also confronted with configuration problems similar to those of single users. However, configured IPsec tunnel nodes are interfaces of the firewalls/routers.

Furthermore, for an enterprise user, if a Multi-Protocol Label Switching (MPLS) Virtual Private Network (VPN) has been used and a service provider of the MPLS VPN may have a Provider Edge (PE) access point in a city where a data centre is located, a VN connection of the enterprise user may be realized by configuring a data centre gateway and a PE.

However, there may exist two problems as follows: 1, the data centre gateway is manually configured; and 2, all the VNs in the data centre are required to be connected and controlled through the data centre gateway, which may make the data centre gateway become a probable bottleneck, thereby limiting extension.

Furthermore, a single Internet user (non-enterprise user) may obtain different IP addresses every time when logging in the Internet, which may cause certain dynamism to tunnel encapsulation and higher security risks. Therefore, security in IPsec tunnel access needs to be further considered.

### SUMMARY

In view of this, a main purpose of the embodiments of the disclosure is to provide a method and a system for accessing a VN, so as to solve the problem that a data centre gateway becomes a bottleneck when an Internet user accesses the VN in a data centre.

To this end, the technical solutions of the disclosure are implemented as follows.

The embodiment of the disclosure provides a method for accessing a VN, which includes:

a Broadband Network (BN)-NVE accepts access of a broadband user terminal to a VN in a data centre, generates a forwarding table about the VN, and forms a forwarding table entry corresponding to the broadband user terminal in the forwarding table;

the BN-NVE performs interaction with an NVE of the VN to be accessed with respect to information of the forwarding table to synchronize information of the forwarding table about the VN; and

the BN-NVE receives a message of the broadband user terminal, searches the forwarding table of the VN according to a destination address of the message, forwards the message to a destination NVE in the VN after tunnel encapsulation, and forwards the message to a destination VM through the destination NVE to implement VN access of the broadband user terminal.

Preferably, the step in which the BN-NVE accepts the access of the broadband user terminal to the NV in the data centre includes:

after the broadband user terminal finds the BN-NVE through an automatic NVE discovery mechanism, the BN-NVE performs VN identity authentication on the broadband user terminal, and accepts the access of the broadband user terminal to the VN in the data centre after the broadband user terminal passes authentication.

Preferably, the BN-NVE supports pre-configuration of the forwarding table of the VN and table entry thereof.

Preferably, before the step in which the BN-NVE performs information interaction with the NVE of the VN to be accessed, the method further includes:

the BN-NVE performs identity authentication with the NVE of the VN to be accessed.

Preferably, the method further includes:

the BN-NVE searches the destination address of the message in the forwarding table about the VN when receiving the message of the broadband user terminal, continues subsequent message encapsulation processing if the destination address is found in the forwarding table about the VN, otherwise processes the message on the basis of a basic routing forwarding mechanism.

Preferably, the broadband user terminal includes: a terminal of a single Internet user, a terminal of a broadband dial-in access enterprise network user and a Customer Edge (CE) of an enterprise network.

Preferably, the method further includes:

the broadband user terminal is a CE of an enterprise network and supports VN access of the enterprise network, and the BN-NVE supports routing interaction with the CE, and when the forwarding table generated by the BN-NVE is an L2 forwarding table, supports translation of Media Access Control (MAC) address information into IP address information and supports implementation of routing interaction with the CE.

Preferably, the BN-NVE includes: a Broadband Remote Access Server (BRAS) of an Internet Service Provider (ISP) network, an Access Router (AR) and a Service Router (SR).

The embodiment of the disclosure further provides a system for accessing a VN, which is applied in a BN-NVE and includes:

a terminal access module, configured to accept access of a broadband user terminal to a VN in a data centre, generate a forwarding table about the VN, and form a forwarding table entry corresponding to the broadband user terminal in the forwarding table;

an information synchronization module, configured to perform interaction with an NVE of the VN to be accessed with respect to information of the forwarding table to synchronize information of the forwarding table about the VN; and

a message processing module, configured to receive a message of the broadband user terminal, search the forwarding table about the VN according to a destination address of the message, forward the message to a destination NVE in the VN after tunnel encapsulation, and forward the message to a destination VM through the destination NVE to implement VN access of the broadband user terminal.

Preferably, the terminal access module is configured to, after the broadband user terminal finds the BN-NVE through an automatic NVE discovery mechanism, perform VN identity authentication on the broadband user terminal, and accept the access of the broadband user terminal to the VN in the data centre after the broadband user terminal passes authentication.

Preferably, the terminal access module supports pre-configuration of the forwarding table about the VN.

Preferably, the information synchronization module is configured to, before performing interaction with the NVE of the VN to be accessed, perform identity authentication with the NVE of the VN to be accessed.

Preferably, the message processing module is configured to search the destination address of the message in the forwarding table about the VN when receiving the message of the broadband user terminal, continue subsequent message encapsulation processing if the destination address is found in the forwarding table about VN, otherwise process the message on the basis of a basic routing forwarding mechanism.

Preferably, the broadband user terminal includes: a terminal of a single Internet user, a terminal of a broadband dial-in access enterprise network user and a CE of an enterprise network.

Preferably, the broadband user terminal is a CE of an enterprise network, and supports VN access of the enterprise network, and the system supports routing interaction with the CE, and when the forwarding table in the system is an L2 forwarding table, supports translation of MAC address information into IP address information and supports implementation of routing interaction with the CE.

Preferably, the BN-NVE includes: a BRAS of an ISP network, an AR and an SR.

The embodiment of the disclosure further provides a method for accessing a VN, which includes:

a VN service development and management entity in a data centre accepts an access request of a broadband user terminal for a VN in the data centre, and selects an NVE of the VN as an access NVE of the VN; and

the access NVE of the VN establishes a security tunnel with the broadband user terminal, and implements VN access of the broadband user terminal through the established security tunnel.

Preferably, the step that the VN service development and management entity in the data centre accepts the access request of the broadband user terminal for the VN in the data centre includes:

the VN service development and management entity performs identity authentication on the broadband user terminal applying for accessing the VN, and accepts the access request of the broadband user terminal for the VN in the data centre after the broadband user terminal passes authentication.

Preferably, the step that the VN service development and management entity selects the NVE of the VN as the access NVE of the VN includes:

the VN service development and management entity performs access point selection according to load and/or processing capability information of all NVEs in the VN,

wherein the load and/or processing capability information of all the NVEs in the VN is obtained by interaction between the VN service development and management entity and all the NVEs in the VN.

Preferably, after the access NVE of the VN is selected, the method further includes:

the VN service development and management entity acquires information of the broadband user terminal, provides the information of the broadband user terminal and type information of the tunnel for the access NVE of the VN, and provides an IP address of the access NVE of the VN and the type information of the tunnel for the broadband user terminal.

Preferably, after the step that the VN service development and management entity provides the information of the broadband user terminal for the access NVE of the VN, the method further includes:

the access NVE of the VN implements configuration of a forwarding table about the VN and a corresponding table entry according to the received information of the broadband user terminal and type information of the tunnel, and establishes correspondence between the forwarding table about the VN and the tunnel.

Preferably, the broadband user terminal includes: a terminal of a single Internet user, a terminal of a broadband dial-in access enterprise network user and a CE of an enterprise network.

Preferably, the method further includes:

the broadband user terminal is a CE of an enterprise network, and supports VN access of the enterprise network, and the access NVE of the VN supports routing interaction with the CE through the security tunnel, and when the forwarding table is an L2 forwarding table, supports translation of MAC address information into IP address information and supports implementation of routing interaction with the CE.

The embodiment of the disclosure further provides a system for accessing a VN, which includes:

a VN service development and management entity in a data centre, configured to accept an access request of a broadband user terminal for a VN in the data centre, and select an NVE of the VN as an access NVE of the VN; and

the access NVE of the VN, configured to establish a security tunnel with the broadband user terminal, and implement VN access of the broadband user terminal through the established security tunnel.

Preferably, the VN service development and management entity includes:

a terminal access module, configured to accept the access request of the broadband user terminal for the VN in the data centre; and

an NVE selection module, configured to select the NVE of the VN as the access NVE of the VN.

Preferably, the terminal access module is configured to perform identity authentication on the broadband user terminal applying for accessing the VN, and accept the access request of the broadband user terminal for the VN in the data centre after the broadband user terminal passes authentication.

Preferably, the NVE selection module is configured to perform access point selection according to load and/or processing capability information of all NVEs in the VN,

wherein the load and/or processing capability information of all the NVEs in the VN is obtained by interaction between the NVE selection module and all the NVEs in the VN.

Preferably, the VN service development and management entity further includes:

an information provision module, configured to acquire information of the broadband user terminal, provide the information of the broadband user terminal and type information of the tunnel for the access NVE of the VN, and provide an IP address of the access NVE of the VN and the type information of the tunnel for the broadband user terminal.

Preferably, the access NVE of the VN includes:

a first processing module, configured to establish the security tunnel with the broadband user terminal; and

a second processing module, configured to implement the VN access of the broadband user terminal through the established security tunnel.

Preferably, the first processing module is configured to implement configuration of a forwarding table about VN and a corresponding table entry according to the received information of the broadband user terminal and type information of the tunnel, and establish correspondence between the VN forwarding table and the tunnel.

Preferably, the broadband user terminal includes: a terminal of a single Internet user, a terminal of a broadband dial-in access enterprise network user and a CE of an enterprise network.

Preferably, the broadband user terminal is a CE of an enterprise network, and supports VN access of the enterprise network, and

correspondingly, the access NVE of the VN further includes a routing interaction module and an address conversion module, wherein the routing interaction module supports routing interaction with the CE through the security tunnel, and when the forwarding table is an L2 forwarding table, the address conversion module supports translation of MAC address information into IP address information and supports implementation of routing interaction with the CE.

Preferably, the access NVE of the VN further includes:

a Network Address Translation (NAT) processing module, configured to process a message generated by directly accessing the Internet by a VM in the VN.

According to the methods and the systems for accessing the VN provided by the embodiments of the disclosure, the access of the broadband user terminal to the VN in the data centre is implemented, and extension and bottleneck problems of the data centre gateway are successfully solved.

### BRIEF DESCRIPTION OF THE DRAWINGS

FIG. 1 is a diagram of an NVO3 network structure for a data centre in an existing technology;

FIG. 2 is a flowchart of a method for accessing a VN according to an embodiment of the disclosure;

FIG. 3 is a network structure diagram of accessing a VN by a broadband user terminal through the Internet according to an embodiment of the disclosure;

FIG. 4 is a flowchart of another method for accessing a VN according to an embodiment of the disclosure; and

FIG. 5 is a structure diagram of directly accessing an NVE of a data centre through a security tunnel by a broadband user terminal according to an embodiment of the disclosure.

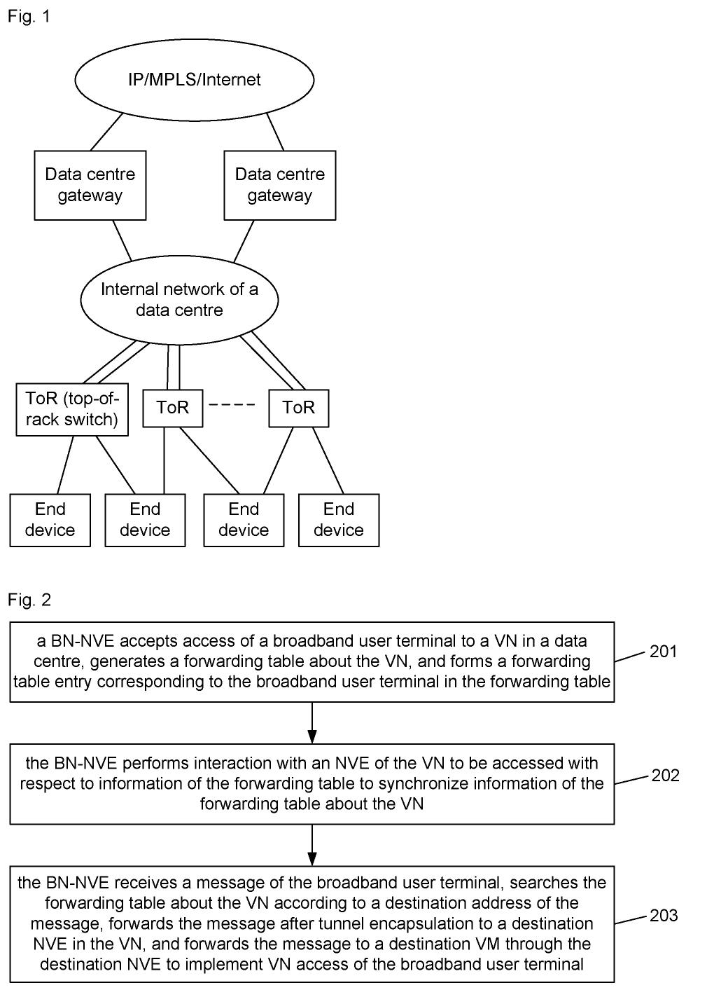

### DETAILED DESCRIPTION

The technical solutions of the disclosure are further described below with reference to the drawings and specific embodiments in detail.

As shown in FIG. 2, a method for accessing a VN provided by the embodiment of the disclosure mainly includes the following steps:

Step 201: a Broadband Network-Network Virtualization Edge (BN-NVE) accepts access of a broadband user terminal to a VN in a data centre, generates a forwarding table of the VN, and forms a forwarding table entry corresponding to the broadband user terminal in the forwarding table.

The NVE is arranged in a BN, and is configured to accept the access of the broadband user terminal to the VN.

After the broadband user terminal accesses the BN, the broadband user terminal needs to pass broadband access authentication of the BN at first, and then obtains an IP address allocated to the broadband user terminal by the BN after passing authentication.

The broadband user terminal passing broadband access authentication triggers a processing process of automatically joining the VN by virtue of an automatic NVE discovery mechanism (specifically an automatic NVE discovery protocol). Specifically, after the broadband user terminal automatically discovers the BN-NVE, the BN-NVE performs VN identity authentication on the broadband user terminal, accepts the access of the broadband user terminal to the VN in the data centre after the broadband user terminal passes authentication, generates the forwarding table of the VN to be accessed in the NVE, and forms a corresponding forwarding table entry of the VN.

It is important to note that the BN-NVE also supports pre-configuration of the forwarding table of the VN and its table entry, that is, the forwarding table of the VN and its table entry can be pre-configured in the BN-NVE, instead of the implementation manner in which the BN-NVE automatically generates the forwarding table of the VN and its table entry.

Step 202: the BN-NVE performs forwarding table information interaction with an NVE of the VN to be accessed to form information synchronization of the forwarding table of the VN.

The BN-NVE performs forwarding table information interaction with the NVE of the VN in the data centre through a control plane protocol. In addition, in order to ensure access security, the BN-NVE performs identity authentication with the NVE of the VN to be accessed before information interaction between the NVEs, and the forwarding table information interaction between the NVEs is allowed only after the NVEs pass the identity authentication of each other.

Step 203: the BN-NVE receives a message from the broadband user terminal, searches the forwarding table of the VN according to a destination address of the message, forwards the message after tunnel encapsulation to a destination NVE in the VN, and forwards the message to a destination Virtual Machine (VM) through the destination NVE to implement VN access of the broadband user terminal.

The BN-NVE looks for the destination address of the message in the forwarding table of the VN when receiving the message of the broadband user terminal, continues subsequent message encapsulation processing if the destination address is found in the forwarding table of the VN, otherwise processes the message on the basis of a basic routing forwarding mechanism.

The broadband user terminal includes: a terminal of a single Internet user, a terminal of a broadband dial-in access enterprise network user and a Customer Edge (CE) of an enterprise network.

The method further includes: the broadband user terminal is a CE of an enterprise network, and supports VN access of the enterprise network, and the BN-NVE supports routing interaction with the CE, and when the forwarding table of the BN-NVE is an L2 forwarding table, supports translation of MAC address information into IP address information and supports implementation of routing interaction with the CE.

The method for accessing the VN according to the disclosure is further described below with reference to a specific example in detail.

In order to implement access to the VN, it is necessary to take some typical application scenarios into consideration, specifically including:

1: a terminal of a single Internet user accesses the VN;

2: a terminal of an enterprise network user accesses the VN; and

3: a terminal of an enterprise network user using an MPLS VPN accesses the VN.

In order to solve extension and bottleneck problems of a data centre gateway, not all VNs in the data centre are required to be processed through the data centre gateway in a centralized manner, and instead the VNs may be processed in a decentralized manner.

In embodiment 1 of the disclosure, a VN may be automatically accessed through cooperation between a network operator and a data centre operator. There may exist two cases as follows:

1: the data centre is also provided by the network operator, i.e. an Internet Server Provider (ISP)/Server Provider (SP). Then, for the access of the broadband user terminal to the VN, the broadband user terminal is connected to the Internet through the BN, and is also connected to the VN of the data centre through the BN. That is, the network of the data centre and the BN are provided by the same manager; and

2: the BN and the VN of the data centre are provided by two different providers, respectively.

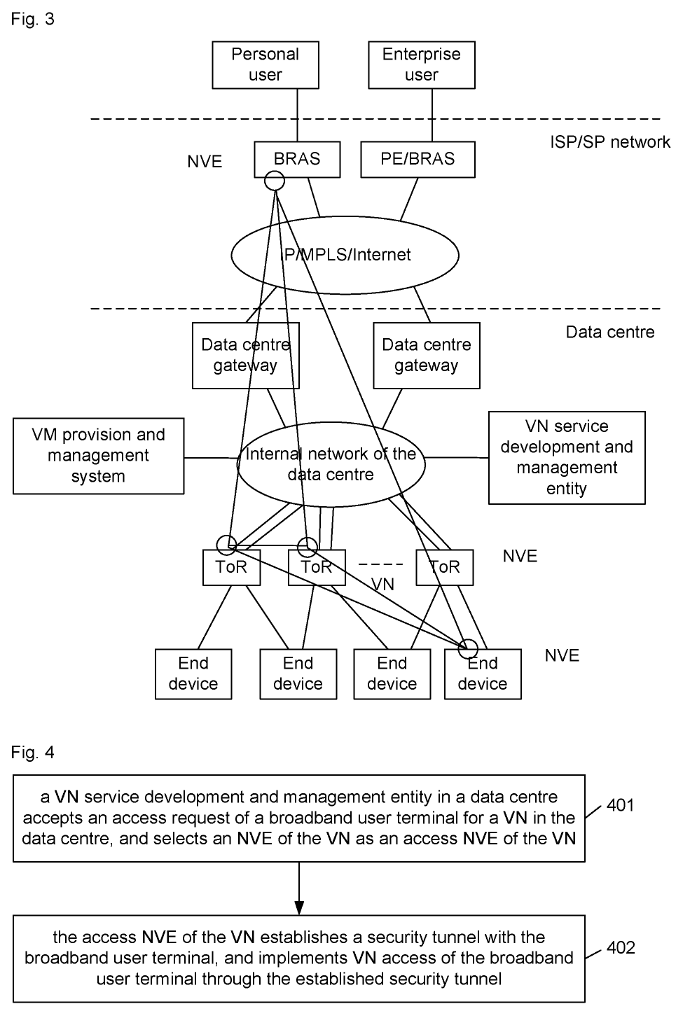

FIG. 3 is a network structure diagram of accessing a VN by a broadband user terminal through the Internet according to an embodiment of the disclosure.

Some NVEs are arranged in the BN. Because the NVO3 is an L3-network-based overlay network technology and an IP/L3 network technology is adopted for the data centre and the BN, the data centre and the BN may be considered as the same IP infrastructure. Thus, the NVO3 is not only limited within a range of the data centre, but also can be expanded to all IP-based Internet infrastructures.

In order to support general access, the NVE may be a Broadband Remote Access Server (BRAS) of an ISP network according to a practical IP network deployment. Alternatively, the NVE is an Access Router (AR) or a Service Router (SR) under the condition of dedicated access of a user. The BRAS may realize the following functions in the BN: identity authentication over the broadband user terminal, isolation from another user through a security channel between the broadband user terminal and the BRAS, IP address allocation and the like. The AR and the SR mainly implement the dedicated access of the user, usually through a fixed configuration, for example, a physical interface or a sub-interface, and an IP address of an accessed network is allocated in advance.

In addition, communications between the BN-NVE and the NVE of the data centre may be supported by extension of a Multiprotocol Border Gateway Protocol (MP-BGP), and even if the network of the data centre and the BN are in two different management domains, the MP-BGP still supports such a case.

Alternatively, communications between the BN-NVE and the NVE of the data centre may also be implemented by a central server. Specifically, since the MP-BGP adopts a fully-connected structure, that is, all related NVEs are connected and implement information interaction, a route reflector is usually adopted to support extension, that is, each NVE communicates with the route reflector to implement information interaction among the NVEs.

The example in which a single Internet user accesses a VN of a data centre is described below.

First, the user has applied for the VN of the data centre. Specifically, an application may be made through a portal of a VN service development and management function entity in FIG. 3, or a service application is made through a business hall of a service provider. Related subscription data is stored in the VN service development and management function entity. The subscription data is not only required to include basic information such as a VN name of the VN, but also required to include a new attribute. Since the user wants to access the VN through the Internet, information that the user further needs to know includes a specific ISP for access, a username and password for access to the VN, and the like. A VM provision and management system in FIG. 3 is configured to provide a function of providing and managing VMs in the VN.

Then, the user terminal is required to support an automatic NVE discovery mechanism to automatically discover an NVE in the ISP, and the NVE may automatically configure one or more attributes about the VN. Alternatively, attribute(s) relating the NVE of the BRAS may also be manually configured to implement the access of the user terminal.

The user terminal may request the NVE to authenticate its identity through a specific VN joining message after automatically discovering the NVE, or the NVE initiates VN identity authentication over the user terminal after being automatically discovered by the user terminal; and after the user terminal passes authentication, the NVE generates a forwarding table of the VN to be accessed in the NVE and a corresponding table entry.

The NVE in the ISP performs information interaction with an NVE in the VN in the data centre through a control plane protocol. Since the NVE of the ISP and the NVE of the data centre may be in different management domains respectively, it is necessary to perform identity authentication on interaction information itself or the NVE. Only after identity authentication succeeds, the BN-BNE performs information interaction with the NVE of the VN to be accessed to implement information synchronization of the forwarding table of the VN.

After the forwarding table is synchronized, the BN-NVE receives a message of the broadband user terminal, searches the forwarding table of the VN according to a destination address of the message, forwards the message to a destination NVE in the VN after tunnel encapsulation, and forwards the message to a destination VM through the destination NVE to implement the VN access of the broadband user terminal.

A specific accessing flow includes two parts in which the first part involves that the broadband user terminal sends a message to a terminal in the VN, and the second part involves that the terminal in the VN sends a message to the broadband user terminal.

The first part specifically includes the following implementation steps:

Step A1: the broadband user terminal has applied for the VN, a data centre service provider has prepared the VN, and the broadband user terminal has been authorized to access the VN; and the broadband user terminal has passed broadband user identity authentication of the BRAS and obtained an IP address, and may access the Internet.

Step A2: the BRAS is upgraded to support an NVE function, and supports an automatic NVE discovery function.

Step A3: the broadband user terminal discovers the NVE, i.e. the BRAS (i.e. the BN-NVE) by virtue of the automatic NVE discovery protocol.

Step A4: the BN-NVE initiates VN identity authentication over the broadband user terminal, generates a forwarding table of the VN in the BN-NVE after the broadband user terminal passes authentication, and forms a table entry of the forwarding table of the VN according to the IP address of the broadband user terminal.

Step A5: the BN-NVE interacts with the NVE in the VN to synchronize information of the forwarding table through the control plane protocol or a data plane learning mechanism. Specifically, before synchronization, it is necessary to perform identity authentication on the NVE to avoid such problems as impersonation and eavesdropping.

Step A6: the BN-NVE performs tunnel encapsulation according to the forwarding table of the VN when receiving a message sent to another terminal in the VN by the broadband user terminal, and sends the message to the opposite NVE.

Step A7: the opposite NVE decapsulates the message, and sends the decapsulated message to the destination terminal in the VN according to the forwarding table of the VN.

The second part specifically includes the following implementation steps:

Step B1: the terminal in the VN encapsulates and sends the message to be sent to the broadband user terminal to the NVE accessed by the broadband user terminal.

Step B2: the NVE searches the forwarding table of the VN to obtain the opposite NVE of the broadband user terminal, i.e. the BN-NVE, and sends the message to the BN-NVE after tunnel encapsulation.

Step B3: the BN-NVE decapsulates the received message, and sends the decapsulated message to the broadband user terminal according to the forwarding table of the VN stored by the BN-NVE.

By the above two parts, the broadband user terminal may access and communicate with the VN.

It is important to further note that the BRAS performs identity authentication on the broadband user terminal and allocates the IP address at first and then the broadband user terminal may access the Internet by virtue of the IP address. If a Point-to-Point Protocol over Ethernet (PPPoE) authentication method is adopted for identity authentication, a security tunnel is formed between the BRAS and the broadband user terminal to forward the message.

Since the BRAS further supports the NVE function, the IP address/MAC address of the broadband user terminal is added into the forwarding table of the NVE as a table entry to associate the broadband user terminal with the VN to implement access to the VN. Herein, the use of the IP address or the MAC address is determined according to the forwarding table of the VN because the forwarding table of the VN may be an L2 forwarding table or an L3 forwarding table. Therefore, the IP address or the MAC address shall also be added into the forwarding table of the BRAS according to the forwarding table of the VN.

It is also important to note that messages not to be sent to the VN, i.e. ordinary Internet access messages, messages of which destination addresses have no corresponding table entries in the forwarding table of the VN in the embodiment of the disclosure, are all processed based on a basic routing forwarding mechanism of the BRAS because all the messages are required to be processed by the forwarding table of the VN after the broadband user terminal accesses the VN. Due to additional processing introduced into the VN to be accessed, the broadband user terminal may immediately quit access to the VN through an explicit command when being not required to access the VN any longer.

Furthermore, the BRAS may additionally perform Access Control List (ACL) processing on traffic of the broadband user terminal, and specifically, after the forwarding table of the VN is synchronized, a destination IP address of the forwarding table is extracted to filter an information flow of the broadband user terminal. When the destination address is matched, a related message is processed according to the forwarding table of the NVE. In such a manner, access to the VN may also be implemented, and overhead is relatively lower.

Furthermore, there is another solution of how to process the case in which the broadband user terminal simultaneously accesses the Internet and the VN by the BRAS. That is, a broadband user terminal authentication mechanism and a automatic NVE discovery mechanism of the BRAS are fully utilized. The BRAS generates a Session-Identifier (ID) which is configured to uniquely determine the broadband user terminal when performing identity authentication on the user terminal by virtue of PPPoE and also generates a similar VN-ID configured to uniquely identify the VN access when performing identity authentication on the VN access. Therefore, the two IDs may be adopted for processing. An encapsulated message with the VN-ID is processed based on the forwarding table of the VN, and a message with the Session-ID is subjected to ordinary BRAS processing. In such a manner, the processing flow is greatly simplified. In the solution, the broadband user terminal is required to know accessible items in the VN to be accessed which are at least required to be configured and differently encapsulated by modifying an existing program.

For the abovementioned flow, it is also important to note that the forwarding table of the VN may be an L2 or L3 forwarding table. The abovementioned flow is described for the case in which the forwarding table of the VN adopts an IP address forwarding table, i.e. the L3 forwarding table. For the L2 forwarding table, the table entry in the forwarding table of the VN are based on the MAC address. Therefore, the forwarding table of the BN-NVE is also required to use the MAC address, and the address may be obtained when the BRAS performs identity authentication on the broadband user terminal, or in an automatic NVE discovery process.

It is important to further note that the ISP is required to support a multicast function to support an automatic learning mechanism during information exchange between the NVEs, particularly when forwarding plane automatic learning mechanism is triggered through the ISP network. In addition, for an enterprise network user in the BN, a method for accessing a VN is similar to the method for accessing by an ordinary broadband user. A BN access point of the enterprise network user is usually an AR or an SR, and is upgraded to support the NVE function. Since such access is usually implemented through a fixed configuration, an automatic discovery process similar to that for the broadband user terminal is not required in the case of the VN access. Instead, the NVE is directly configured. That is, a corresponding forwarding table of a VN is configured on the SR/AR, and a corresponding forwarding table entry may also be configured. Then, forwarding table information synchronization is performed between the NVEs, and a message encapsulation processing flow is substantially the same as the flow for the ordinary broadband user terminal. The difference is that the forwarding table entry may be directly formed because the broadband user terminal has only one IP address whereas for an enterprise network user, an enterprise network may be a complicated network, and detailed internal routing information is not allowed in the forwarding table of the VN. On one hand, many table entries may be generated by much routing information. On the other hand, internal information of the enterprise network is required to be prevented from being published or transmitted on an external network as much as possible. Therefore, an interface address of a router (CE) connected with the SR/AR may be introduced into the forwarding table entries of the VN. In such a manner, intercommunication between the enterprise network and the VN may be implemented. Specifically, the process may be implemented by configuring the CE. However, since the VN is dynamically variable, the best solution is to run a routing protocol for dynamic routing interaction between the SR/AR and the CE.

It is also important to note that the above description is for the case in which the forwarding table of the VN is an L3 forwarding table. For the case in which the forwarding table of the VN is an L2 forwarding table, interfaces of the SR/AR and the CE do not support L2 routing table entries. Therefore, it is necessary to convert MAC table entries of the SR/AR into corresponding IP router table entries. This is a new function to be supported by the SR/AR. Furthermore, it is necessary to include both MAC address and IP address information fields in the forwarding table entries of the VN and a forwarding table synchronous updating message.

The NVE accessed by the user terminal directly performs information interaction with the NVE of the data centre without the data centre gateway, so that the bottleneck problem of the data centre gateway may be solved.

In the embodiment shown in FIG. 3, automatic access and trans-domain NVE interaction are implemented and the extension problem is solved. However, the operator of the data centre network may implement the access of the broadband user terminal with the support of network deployment of the ISP, i.e. upgrading of an ISP network device/function, if the data centre operator and the ISP are not the same operator. Therefore, other solutions are required. A VN service of the data centre shall be developed without influence of an uncontrollable external factor by a data centre service provider.

It is important to further note that the embodiment of the disclosure implements the access of the BN user and simultaneously may support connection of the VN to the Internet. Specifically, a default route may be set in the NVE of the VN, and when the destination address in the VN in the forwarding table cannot be matched, or the destination address of the VN cannot be accessed, the message is forwarded to the Internet through the default route. During specific implementation, the message is forwarded to a specific processing function entity, for example, a Network Address Translation (NAT) function entity. Since the VM of the VN usually uses a private IP address, address translation for translating the private IP address into a public network IP address for the Internet access of the user is required. The address is usually provided by the operator and configured for a NAT device. Of course, the NAT device may also be implemented by the NVE.

Of course, service flow in the VN may also be returned to the enterprise network for centralized Internet access processing.

Specifically, an access point of the NVE of the VN to an Internet is configured and implemented according to requirements of the VN user.

The embodiment of the disclosure further provides a method for accessing a VN, as shown in FIG. 4, which mainly includes the following steps.

Step 401: a VN service development and management entity in a data centre accepts an access request from a broadband user terminal for a VN in the data centre, and selects an NVE of the VN as an access NVE of the VN.

Preferably, the VN service development and management entity performs identity authentication on the broadband user terminal applying for accessing the VN, and accepts the access request of the broadband user terminal for the VN in the data centre after the broadband user terminal passes authentication.

The VN service development and management entity performs access point selection according to load and/or processing capability information of all NVEs in the VN, wherein the load and/or processing capability information of all the NVEs in the VN is obtained by interaction between the VN service development and management entity and all the NVEs in the VN.

After the access NVE of the VN is selected, the VN service development and management entity acquires information of the broadband user terminal, provides the information of the broadband user terminal and type information of the tunnel for the access NVE of the VN, and provides an IP address of the access NVE of the VN and the type information of the tunnel for the broadband user terminal.

After the VN service development and management entity provides the information of the broadband user terminal for the access NVE of the VN, the access NVE of the VN implements configuration of a forwarding table of the VN and a corresponding table entry according to the received information of the broadband user terminal and type information of the tunnel, and establishes correspondence between the forwarding table of the VN and the tunnel.

Step 402: the access NVE of the VN establishes a security tunnel with the broadband user terminal, and implements VN access of the broadband user terminal through the established security tunnel.

The broadband user terminal includes: a terminal of a single Internet user, a terminal of a broadband dial-in access enterprise network user and a CE of an enterprise network.

Preferably, the broadband user terminal is a CE of an enterprise network, and supports VN access of the enterprise network, and the access NVE of the VN supports routing interaction with the CE through the security tunnel, and when an NVE forwarding table is an L2 forwarding table, supports translation of MAC address information into IP address information and supports implementation of routing interaction with the CE.

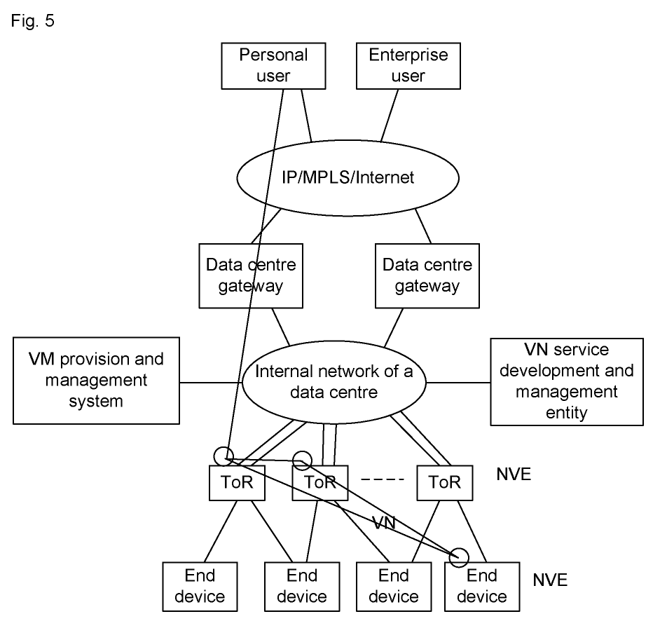

FIG. 5 is a structure diagram of directly accessing an NVE of a data centre through a security tunnel by a broadband user terminal according to an embodiment of the disclosure. AVM provision and management system in FIG. 5 is configured to provide a function of providing and managing VMs in the VN.

A basic idea is that an external access user is only associated with an NVE of a VN accessed by the user, and centralized processing of a data centre gateway is not required. Therefore, it is necessary to directly lead a tunnel of the Internet user to the NVE of the VN, which solves the bottleneck problem of the data centre gateway and also implements access.

A main method includes: a VN service development and management entity in a data centre accepts an access request of a broadband user terminal to the VN in the data centre, establishes a security tunnel between the broadband user terminal and the NVE of the VN to be accessed, and implements VN access of the broadband user terminal through the established security tunnel.

After the user subscribes the VN, the user may apply for accessing the VN through a specific machine. Since access is implemented through the Internet, it is necessary to perform identity authentication on the access user on the Internet and ensure an accessed content of the VN is isolated from the Internet as well as another VN. Therefore, the security tunnel, for example, IPsec, may be established between the user terminal and the VN to implement secure access of the terminal to the VN. Of course, the security tunnel may be any other tunnel, for example, a Generic Routing Encapsulation (GRE) tunnel, and secure isolation may be implemented by encrypting a load (information transmitted in the tunnel).

Since the broadband user terminal may dynamically access the network, and IP addresses every time when the broadband user terminal logs in the BN may be different, the user terminal may apply for joining the VN through a service provision portal of the VN service development management entity when necessary after logging in the BN to ensure automatic and secure access. Here, it is necessary to authenticate the VN identity of the user terminal and further obtain the IP address of the user terminal. The service provision portal selects an NVE for tunnel access. Specifically, the VN service development and management entity needs to interact with the NVEs of the VN after VN deployment, or the NVEs need to actively interact with the VN service development and management entity to report information such as the number of the NVEs in the VN, IP addresses of the NVEs and probable processing capability and load conditions of the NVEs. When the broadband user terminal requires to access the VN, the VN service development and management entity may select an NVE for the access of the broadband user terminal according to the comprehensive conditions of processing capabilities or loads or the like of the NVEs in the VN.

After the user passes identity authentication, the IP address of the selected NVE is returned to the user terminal, with type information of the tunnel contained. Therefore, the security tunnel may be formed between the user terminal and the NVE.

The VN service development and management entity notifies the selected NVE of related information of the user terminal, including the IP address and the like, after the user passes identity authentication, and the NVE automatically configures its NVE forwarding table, and makes a related table entry of the forwarding table correspond to the tunnel, thereby implementing information intercommunication.

It is important to note that the NVE may support L3 and L2 forwarding tables. For an L3 forwarding table, the IP address of the user terminal may be directly used; and for an L2 forwarding table, it is necessary to perform address translation between an MAC address and the IP address to form a compatible L2 forwarding table. However, since information is forwarded still on the basis of IP address, the original IP address corresponding to an information flow output from the VN is required to be found after a forwarding destination is determined, and the IP address is adopted for tunnel encapsulation.

A specific access flow includes two parts in which the first part involves that the broadband user terminal sends a message to a terminal in the VN, and the second part involves that the terminal in the VN sends a message to the broadband user terminal.

The first part specifically includes the following implementation steps:

Step C1: the broadband user has applied for the VN or authorized to access the VN; and the broadband user terminal has passed broadband user identity authentication of the BRAS and obtained an IP address, and may access the Internet. A data centre operator or a VN service provider sets a VN service development and management function entity in the data centre, and a service provision portal is set in the VN service development and management function entity, which may be accessed by the user on the Internet, perform service application, i.e. identity authentication of related user, and the like. The data centre service provider has prepared the VN. Furthermore, the VN service development and management function entity includes information of all the NVEs of the VN, such as IP addresses of the NVEs.

Step C2: the broadband user logs in the service provision portal, applies for accessing the VN, and submits the IP address of the broadband user terminal to the service provision portal, or the service provision portal directly acquires the IP address of the broadband user terminal through the message of the broadband user terminal.

Step C3: the service provision portal initiates VN identity authentication over the broadband user, and selects one NVE from all the NVEs of the VN as a VN access point of the broadband user terminal according to information such as processing capability and load conditions of the NVEs and locations of the NVEs after the broadband user passes authentication.

Step C4: the VN service development and management function entity respectively sends the IP address of the NVE and the IP address of the broadband user terminal to the broadband user terminal and the selected NVE as IP addresses of a starting point and an end point of the security tunnel for access of the broadband user terminal to the VN. Furthermore, it is necessary to add the IP address of the broadband user terminal into a VN forwarding table of the selected NVE as a new forwarding table entry.

Step C5: the NVE selected by the VN service development and management function entity interacts with the other NVEs in the VN to implement synchronization of the VN forwarding table through a control plane protocol or a data plane learning mechanism.

Step C6: the broadband user terminal sends the message to the other terminals in the VN, wherein VN access security tunnel encapsulation over the message is required, an IPsec tunnel or another IP-in-IP tunnel may specifically be selected, and endpoints of the tunnel are the IP addresses of the broadband user terminal and the selected NVE respectively.

Step C7: the selected NVE receives and decapsulates the message encapsulated through the security tunnel from the broadband user terminal to obtain the original message at first, searches the VN forwarding table according to a destination IP address of the message, performs tunnel encapsulation on the message and sends the message to the opposite NVE. If the target terminal is connected to the selected NVE, the message is directly sent to the corresponding terminal.

Step C8: the opposite NVE decapsulates the received message, and sends the decapsulated message to the corresponding target terminal according to the VN forwarding table.

The second part specifically includes the following implementation steps:

Step D1: the terminal in the VN encapsulates and sends the message to be sent to the broadband user terminal to the NVE accessed by the broadband user terminal.

Step D2: the NVE searches the VN forwarding table to obtain the opposite NVE of the broadband user terminal, i.e. the selected access NVE of the VN, and sends the message to the opposite NVE after encapsulation.

Step D3: the opposite NVE decapsulates the received message, encapsulates the decapsulated message through the security tunnel according to the VN forwarding table, and sends the message to the broadband user terminal through a BN.

By the above two parts, the broadband user terminal may access and communicate with the VN.

It is important to further note that the VN forwarding table may be an L2 or L3 forwarding table. For the case in which the VN forwarding table is an L2 forwarding table, the MAC address of the broadband user terminal may adopt the MAC address of the access NVE of the VN. During message encapsulation processing, the message is encapsulated and forwarded according to the MAC address of the access NVE of the VN, and when the message leaves the VN, security tunnel encapsulation is further required.

In addition, for an enterprise network user on the BN, the abovementioned similar security tunnel encapsulation access manner may also be adopted. The specific processing process is similar to the abovementioned flow, and the main difference is that a security tunnel between an Internet access interface of the CE of the enterprise network user and the access NVE of the VN may be directly configured.

The embodiment shown in FIG. 5 is also applied to an enterprise user, and the difference between direct access of the enterprise user to the NVE of the data centre through the security tunnel and the abovementioned embodiment is that: the IP address is fixed because the enterprise user usually adopts dedicated access. That is, the security tunnel is directly configured between the NVE and a border router of the enterprise network, thereby implementing the VN access of the enterprise user.

The broadband dial-in access is also applied to the enterprise user, and a mechanism similar to the abovementioned embodiment may be adopted to implement tunnel access. Internal information of the enterprise network is inaccessible for the BRAS under a dial-in condition, so the same mechanism as the above may be adopted to implement VN access without special processing.

In addition, for access of the terminal of the enterprise network user employing the MPLS VPN, since the MPLS VPN is a larger infrastructure and the main body of the enterprise network, the VN may usually be manually configured to access the VPN as a station of the VPN. Specifically, one NVE of the data centre is configured as a CE, and a corresponding PE is configured. Thus, a security tunnel is formed, thereby implementing VPN access.

It is also important to note that the access NVE of the VN of the data centre needs to support a routing switching function, and also needs to realize a probable function of translating the MAC address into the IP address.

Corresponding to the method for accessing the VN as shown in FIG. 2, the embodiment of the disclosure provides a system for accessing a VN, which is applied for a BN-NVE. The system includes the following modules.

A terminal access module is configured to accept access of a broadband user terminal to a VN in a data centre, generate a VN forwarding table, and form a forwarding table entry corresponding to the broadband user terminal in the forwarding table.

An information synchronization module is configured to perform forwarding table information interaction with an NVE of the accessed VN to form information synchronization of the VN forwarding table.

A message processing module is configured to receive a message of the broadband user terminal, search the VN forwarding table according to a destination address of the message, forward the message to a destination NVE in the VN after tunnel encapsulation, and forward the message to a destination VM through the destination NVE to implement VN access of the broadband user terminal.

Preferably, the message processing module is configured to receive the message of the broadband user terminal, search the VN forwarding table according to the destination address of the message, forward the message to the destination NVE in the VN after tunnel encapsulation, and forward the message to the destination VM through the destination NVE to implement the VN access of the broadband user terminal.

Preferably, the terminal access module supports pre-configuration of the VN forwarding table.

Preferably, the information synchronization module is configured to, before performing information interaction with the NVE of the accessed VN, perform identity authentication with the NVE of the accessed VN.

Preferably, the message processing module is configured to searches the destination address of the message in the VN forwarding table when receiving the message of the broadband user terminal, continue subsequent message encapsulation processing if the destination address is found in the VN forwarding table, otherwise process the message on the basis of a basic routing forwarding mechanism.

Preferably, the broadband user terminal includes: a terminal of a single Internet user, a terminal of a broadband dial-in access enterprise network user and a CE of an enterprise network.

Preferably, the access NVE of the VN further includes a routing interaction module and an address conversion module, wherein the routing interaction module supports routing interaction with the CE through the security tunnel, and when an NVE forwarding table is an L2 forwarding table, the address conversion module supports translation of MAC address information into IP address information and supports implementation of routing interaction with the CE.

Preferably, the access NVE of the VN further includes: a NAT processing module, configured to process a message generated by directly accessing the Internet by a VM in the VN.

The BN-NVE includes: a BRAS of an ISP network, an AR and an SR.

Corresponding to the method for accessing the VN as shown in FIG. 4, the embodiment of the disclosure provides a system for accessing a VN, which includes:

a VN service development and management entity in a data centre, configured to accept an access request of a broadband user terminal for a VN in the data centre, and select an NVE of the VN as an access NVE of the VN; and

the access NVE of the VN, configured to establish a security tunnel with the broadband user terminal, and implement VN access of the broadband user terminal through the established security tunnel.

Preferably, the VN service development and management entity includes:

a terminal access module, configured to accept the access request of the broadband user terminal for the VN in the data centre; and

an NVE selection module, configured to select the NVE of the VN as the access NVE of the VN.

Preferably, the terminal access module is configured to perform identity authentication on the broadband user terminal applying for accessing the VN, and accept the access request of the broadband user terminal for the VN in the data centre after the broadband user terminal passes authentication.

Preferably, the NVE selection module is configured to perform access point selection according to load and/or processing capability information of all NVEs in the VN,

wherein the load and/or processing capability information of all the NVEs in the VN is obtained by interaction between the NVE selection module and all the NVEs in the VN.

Preferably, the VN service development and management entity further includes:

an information provision module, configured to acquire information of the broadband user terminal, provide the information of the broadband user terminal and type information of the tunnel for the access NVE of the VN, and provide an IP address of the access NVE of the VN and the type information of the tunnel for the broadband user terminal.

Preferably, the access NVE of the VN includes:

a first processing module, configured to establish the security tunnel with the broadband user terminal; and

a second processing module, configured to implement the VN access of the broadband user terminal through the established security tunnel.

Preferably, the first processing module is configured to implement configuration of a VN forwarding table and a corresponding table entry according to the received information of the broadband user terminal and type information of the tunnel, and establish correspondence between the VN forwarding table and the tunnel.

Preferably, the broadband user terminal includes: a terminal of a single Internet user, a terminal of a broadband dial-in access enterprise network user and a CE of an enterprise network.

Preferably, the broadband user terminal is a CE of an enterprise network, and supports VN access of the enterprise network, and

correspondingly, the access NVE of the VN further includes a routing interaction module and an address conversion module, wherein the routing interaction module supports routing interaction with the CE through the security tunnel, and when an NVE forwarding table is an L2 forwarding table, the address conversion module supports translation of MAC address information into IP address information and supports implementation of routing interaction with the CE.

Preferably, the access NVE of the VN further includes: a NAT processing module, configured to process a message generated by directly accessing the Internet by a VM in the VN.

The above is only the preferred embodiment of the disclosure and not intended to limit the scope of protection of the disclosure.

What is claimed is:

1. A method for accessing a Virtual Network (VN), comprising:
accepting, by a Broadband Network-Network Virtualization Edge (BN-NVE), access of a broadband user terminal to a VN in a data centre, generating a forwarding table about the VN, and forming a forwarding table entry corresponding to the broadband user terminal in the forwarding table;
performing, by the BN-NVE, interaction with an NVE of the VN to be accessed with respect to information of the forwarding table to synchronize information of the forwarding table about the VN; and
receiving, by the BN-NVE, a message of the broadband user terminal, searching the forwarding table about the VN according to a destination address of the message, forwarding the message after tunnel encapsulation to a destination NVE in the VN, and forwarding the message to a destination Virtual Machine (VM) through the destination NVE to implement access of the broadband user terminal to the VN.

2. The method according to claim 1, wherein the step of accepting, by the BN-NVE, the access of the broadband user terminal to the VN in the data centre comprises:
after the broadband user terminal finds the BN-NVE through an automatic NVE discovery mechanism, performing, by the BN-NVE, VN identity authentication on the broadband user terminal, and accepting the access of the broadband user terminal to the VN in the data centre after the broadband user terminal passes authentication.

3. The method according to claim 1, wherein the BN-NVE supports pre-configuration of the forwarding table about the VN and table entry thereof, and
wherein the method further comprises:
before the step of performing, by the BN-NVE, interaction with the NVE of the VN to be accessed,
performing, by the BN-NVE, identity authentication with the NVE of the VN to be accessed.

4. (canceled)

5. The method according to claim 1, further comprising:
searching, by the BN-NVE, the destination address of the message in the forwarding table about the VN when receiving the message of the broadband user terminal, continuing subsequent message encapsulation processing if the destination address is found in the forwarding table about the VN, otherwise processing the message on the basis of a basic routing forwarding mechanism.

6. The method according to claim 1, wherein the broadband user terminal comprises: a terminal of a single Internet user, a terminal of a broadband dial-in access enterprise network user and a Customer Edge (CE) of an enterprise network; and
wherein the BN-NVE comprises: a Broadband Remote Access Server (BRAS) of an Internet Service Provider (ISP) network, an Access Router (AR) and a Service Router (SR),
wherein the method further comprises:
when the broadband user terminal is a CE of an enterprise network and supports VN access of the enterprise network, supporting, by the BN-NVE, routing interaction with the CE; and
when the forwarding table generated by the BN-NVE is a Layer-2 (L2) forwarding table, supporting translation of Media Access Control (MAC) address information into Internet Protocol (IP) address information and supporting implementation of routing interaction with the CE.

7. (canceled)

8. (canceled)

9. A system for accessing a Virtual Network (VN), applied in a Broadband Network-Network Virtualization Edge (BN-NVE), the system comprising:
a terminal access module, configured to accept access of a broadband user terminal to a VN in a data centre, generate a forwarding table about the VN, and form a forwarding table entry corresponding to the broadband user terminal in the forwarding table;
an information synchronization module, configured to perform interaction with an NVE of the VN to be accessed with respect to information of the forwarding table to synchronize information of the forwarding table about the VN; and
a message processing module, configured to receive a message of the broadband user terminal, search the forwarding table about the VN according to a destination address of the message, forward the message after tunnel encapsulation to a destination NVE in the VN, and forward the message to a destination VM through the destination NVE to implement access of the broadband user terminal to the VN.

10. The system according to claim 9, wherein the terminal access module is configured to, after the broadband user terminal finds the BN-NVE through an automatic NVE discovery mechanism, perform VN identity authentication on the broadband user terminal, and accept the access of the broadband user terminal to the VN in the data centre after the broadband user terminal passes authentication; and
wherein the information synchronization module is configured to, before performing interaction with the NVE of the VN to be accessed, perform identity authentication with the NVE of the VN to be accessed.

11. The system according to claim 9, wherein the terminal access module supports pre-configuration of the forwarding table about the VN.

12. (canceled)

13. The system according to claim 9, wherein the message processing module is configured to search the destination address of the message in the forwarding table about the VN when receiving the message of the broadband user terminal, continue subsequent message encapsulation processing if the destination address is found in the forwarding table about the VN, otherwise process the message on the basis of a basic routing forwarding mechanism.

14. The system according to claim 9, wherein the broadband user terminal comprises: a terminal of a single Internet user, a terminal of a broadband dial-in access enterprise network user and a Customer Edge (CE) of an enterprise network; and
wherein the BN-NVE comprises: a Broadband Remote Access Server (BRAS) of an Internet Service Provider (ISP) network, an Access Router (AR) and a Service Router (SR);
wherein when the broadband user terminal is a CE of an enterprise network and supports VN access of the enterprise network, the system supports routing interaction with the CE; and
when the forwarding table generated by the system is a Layer-2 (L2) forwarding table, the system further supports translation of Media Access Control (MAC) address information into Internet Protocol (IP) address information and supports implementation of routing interaction with the CE.

15. (canceled)

16. (canceled)

17. A method for accessing a Virtual Network (VN), comprising:
accepting, by a VN service development and management entity in a data centre, an access request of a broadband user terminal for a VN in the data centre, and selecting a Network Virtualization Edge (NVE) of the VN as an access NVE of the VN; and
establishing, by the access NVE of the VN, a security tunnel with the broadband user terminal, and implements VN access of the broadband user terminal through the established security tunnel.

18. The method according to claim 17, wherein the step of accepting, by the VN service development and management entity in the data centre, the access request of the broadband user terminal for the VN in the data centre comprises:
performing, by the VN service development and management entity, identity authentication on the broadband user terminal applying for accessing the VN, and accepting the access request of the broadband user terminal for the VN in the data centre after the broadband user terminal passes authentication.

19. The method according to claim 17, wherein the step of selecting, by the VN service development and management entity, the NVE of the VN as the access NVE of the VN comprises:
performing, by the VN service development and management entity, access point selection according to load and/or processing capability information of all NVEs in the VN,
wherein the load and/or processing capability information of all the NVEs in the VN is obtained by interaction between the VN service development and management entity and all the NVEs in the VN.

20. The method according to claim 17, further comprising:
after the access NVE of the VN is selected, acquiring, by the VN service development and management entity, information of the broadband user terminal, providing the information of the broadband user terminal and type information of the tunnel for the access NVE of the VN, and providing an Internet Protocol (IP) address of the access NVE of the VN and the type information of the tunnel for the broadband user terminal,
after providing, by the VN service development and management entity, the information of the broadband user terminal for the access NVE of the VN, implementing, by the access NVE of the VN, configuration of a forwarding table about the VN and a corresponding table entry according to the received information of the broadband user terminal and type information of the tunnel, and establishing correspondence between the forwarding table and the tunnel.

21. (canceled)

22. The method according to claim 17, wherein the broadband user terminal comprises: a terminal of a single Internet user, a terminal of a broadband dial-in access enterprise network user and a Customer Edge (CE) of an enterprise network,
wherein the method further comprises:
when the broadband user terminal is a CE of an enterprise network and supports VN access of the enterprise network, supporting, by the access NVE of the VN, routing interaction with the CE through the security tunnel; and
when the forwarding table is a Layer-2 (L2) forwarding table, supporting translation of Media Access Control (MAC) address information into Internet Protocol (IP) address information and supporting implementation of routing interaction with the CE.

23. (canceled)

24. A system for accessing a Virtual Network (VN), comprising:
a VN service development and management entity in a data centre, configured to accept an access request of a broadband user terminal for a VN in the data centre, and select a Network Virtualization Edge (NVE) of the VN as an access NVE of the VN; and
the access NVE of the VN, configured to establish a security tunnel with the broadband user terminal, and implement VN access of the broadband user terminal through the established security tunnel.

25. The system according to claim 24, wherein the VN service development and management entity comprises:
a terminal access module, configured to accept the access request of the broadband user terminal for the VN in the data centre; and
an NVE selection module, configured to select the NVE of the VN as the access NVE of the VN.

26. The system according to claim 25, wherein the terminal access module is configured to perform identity authentication on the broadband user terminal applying for accessing the VN, and accept the access request of the broadband user terminal for the VN in the data centre after the broadband user terminal passes authentication,
wherein the NVE selection module is configured to perform access point selection according to load and/or processing capability information of all NVEs in the VN,
wherein the load and/or processing capability information of all the NVEs in the VN is obtained by interaction between the NVE selection module and all the NVEs in the VN.

27. (canceled)

28. The system according to claim 25, wherein the VN service development and management entity further comprises:
an information provision module, configured to acquire information of the broadband user terminal, provide the information of the broadband user terminal and type information of the tunnel for the access NVE of the VN, and provide an Internet Protocol (IP) address of the access NVE of the VN and the type information of the tunnel for the broadband user terminal.

29. The system according to claim 28, wherein the access NVE of the VN comprises:
a first processing module, configured to establish the security tunnel with the broadband user terminal; and
a second processing module, configured to implement the VN access of the broadband user terminal through the established security tunnel,
wherein the first processing module is configured to implement configuration of a forwarding table about the VN and a corresponding table entry according to the received information of the broadband user terminal and the type information of the tunnel, and establish correspondence between the forwarding table about the VN and the tunnel,
wherein the access NVE of the VN further comprises:
a Network Address Translation (NAT) processing module, configured to process a message generated by directly accessing the Internet by a Virtual Machine (VM) in the VN,
wherein the broadband user terminal comprises: a terminal of a single Internet user, a terminal of a broadband dial-in access enterprise network user and a Customer Edge (CE) of an enterprise network,
wherein when the broadband user terminal is a CE of an enterprise network and supports VN access of the enterprise network,
the access NVE of the VN further comprises a routing interaction module and an address conversion module,
wherein the routing interaction module is configured to support routing interaction with the CE through the security tunnel; and
the address conversion module is configured to, when the forwarding table is a Layer-2 (L2) forwarding table, support translation of Media Access Control (MAC) address information into IP address information and support implementation of routing interaction with the CE.

30. (canceled)

31. (canceled)

32. (canceled)

33. (canceled)
